(19) United States
(12) Patent Application Publication
(10) Pub. No.: US 2009/0231299 A1
(43) Pub. Date: Sep. 17, 2009

(54) TOUCH CONTROL DISPLAY SCREEN APPARATUS WITH A BUILT-IN ELECTROMAGNETIC INDUCTION LAYER OF WIRE LATTICE

(75) Inventor: XUANMING SHI, Gungdong Province (CN)

Correspondence Address: J C PATENTS, INC., 4 VENTURE, SUITE 250, IRVINE, CA, 92618, US

(73) Assignee: TAIGUEN TECHNOLOGY (SHEN ZHEN) CO., LTD., Guangdong Province (CN)

(21) Appl. No.: 12/433,578

(22) Filed: Apr. 30, 2009

Related U.S. Application Data
(63) Continuation-in-part of application No. 10/527,848, filed on Mar. 15, 2005.

(30) Foreign Application Priority Data
Sep. 16, 2002 (CN) 02257334.8

(51) Int. Cl. G06F 3/041

(52) U.S. Cl. 345/173

(57) ABSTRACT

A touch control display screen with a built-in electromagnetic induction layer of wire lattice includes at least a display screen and a housing. An induction layer is provided behind the display screen and is connected to the induction collection control circuit by its output. A control circuit of display screen is provided in the housing. The induction layer is a wire lattice winded and interlaced separately by the wires along the X and Y axes. The wires are insulated with each other at the crossing points. The space within each lattice unit constitutes one induction cell. Because the electromagnetic induction layer is placed behind the display screen and a printed electromagnetic induction antenna array with flexible membrane is adopted as a recognition induction element, it is easy to manufacture and the cost is low.

### CROSS-REFERENCE TO RELATED APPLICATIONS

This application is a continuation-in-part of application Ser. No. 10/527,848 with a 371(c) date of Mar. 15, 2005, which is a national phase application of international application No. PCT/CN2002/000688 filed on Sep. 27, 2002, which in turn claims the priority benefits of Chinese application No. 02257334.8 filed on Sep. 16, 2002. The contents of these prior applications are hereby incorporated by reference in their entirety.

### FIELD OF THE INVENTION

The present invention relates to a touch screen, particularly to a touch control display screen with a built-in electromagnetic induction layer of wire lattice. The present invention belongs to the field of electronics and electrical appliance technologies.

### BACKGROUND OF THE INVENTION

As a consequence of the popularization and application of computer technology, the ways for converting information into electronic and digital forms are becoming more and more abundant. People have invented all kinds of methods for completing the initial process of digitization of information using various computer peripheral equipments. For example, various keyboard input methods, speech recording input, graphics collection, etc., the most effective and most convenient way is to perform input of information or command directly on a display screen by a method such as touching and pointing. For example, when making drawings by computer, the operation by mouse cannot be as dexterous as the operation by pen, it inevitably obstructs people from skillfully completing fine pattern production. By adopting touch screen and directly operating on the display screen by a touch control pen, the operation is just like drawing on paper, therefore the entire work is very easy to complete, and the effect is relatively good. Also, as a consequence of continuous promotion of portable products, the various peripheral equipments such as keyboard and mouse are all being omitted. For example, the PDA does not have key operation basically, but it entirely uses touch control pen to complete the various operations of a touch screen.

The existing touch control panel mainly uses an electrical resistance type method. In a concrete configuration thereof, a transparent touch membrane is provided on the out side of the display screen, the touch membrane is coated on the surface by an electrical resistance layer; when an operation indicates a specific location on the touch membrane, the change of electrical potential of the location is acquired through computation by a subsequently connected recognition and control circuit, and determines the coordinates of the indicated location, whereby the corresponding operation is executed. Because the existing electrical resistance type has problems such as high cost, complex technique, low precision, and unsuitability for performing handwriting input when realizing large-dimensional touch control panels, and because many times of operation causes physical damages like wear, which leads to problems of shortened operating life of the touch membrane, the applications of the touch screen are greatly limited.

### SUMMARY OF THE INVENTION

The object of the invention is to overcome the various disadvantages of the technology described above, and to provide a touch control display screen with a built-in electromagnetic induction layer of wire lattice having simple manufacturing technique, low cost, high precision of recognition and collection, and long operating life.

The object of the present invention is achieved by the following technical solutions:

A touch control display screen with a built-in electromagnetic induction layer of wire lattice includes at least a display screen and a housing. An induction layer is provided behind the display screen and is connected to the induction collection control circuit by its output. A control circuit of the display screen is provided in the housing. The said induction layer may be a wire lattice winded and interlaced by the wires along the X and Y axes. The wires are insulated with each other at the crossing points. The space within each lattice unit constitutes one induction cell.

The area of said induction layer is same as or smaller than those of the display screen, that is, the induction layer is entirely or partially attached on the rear of the display screen. The induction layer is positioned at one side or center of the display scope of the display screen.

A shield layer is provided behind the induction layer in order to enhance the anti-interference ability of the device.

A buffering layer is provided between the induction layer and the shield layer.

A spatial gap is kept between the shield layer and the control circuit of the display screen.

The induction layer is a wire lattice winded and interlaced by the wires along the X and Y axes, and the surface of the wires is wholly covered or coated by an insulated layer. Alternatively, the wires are enameled wires.

In order to position the winding wire lattice strictly, the wire lattice is attached and fixed on the insulated membrane by thermal pressing or thermal melting process, so as to form the wire lattice electromagnetic induction layer with an insulated membrane. The insulated membrane is film material so as to lower the cost.

In order to improve the induction precision of the induction layer, more than one induction layer are overlaid together, and the induction cells on respective induction layers are set to interlace each other. The interval sizes of the said induction cells on respective layers are same or different.

The induction control circuit and the induction layer are integrated by direct connection, the components of the induction control circuit are positioned on the output of the wire lattice, and the induction control circuit is positioned in the housing.

The said components of the induction control circuit also are mounted on a printed circuit board, which is separated from the induction layer; the output of the wire lattice of the induction layer is connected to the corresponding input terminal on the printed circuit board by means of pressure-connection, plug-in connection or welding connection.

The said output of the wire lattice of the induction layer is positioned between a hard sheet and a printed circuit board. A buffering layer is positioned between the hard sheet and the output of the wire lattice. The hard sheet, buffering layer and the output of the wire lattice are overlaid on the printed circuit board by means of the screwing and pressing connection. The output of the wire lattice is connected to the corresponding input terminal on the printed circuit board.

The printed circuit board is the printed circuit board of the control circuit of the display screen inside the body of the display screen.

The printed circuit board is the printed circuit board of the control circuit of the display screen positioned outside the body of the display screen; or can be the individual device or set on the main board of the PC, and they are connected each other by cables.

The induction control circuit can be positioned outside the body, and connected to the body through the electrical connection means. The output of the wire lattice of the induction layer is connected with the output interface of the induction layer by means of pressure-connection, plug-in connection or welding-connection. On the control circuit, an interface that can match the electrical connection means of the induction layer is provided.

The output interface of the induction layer and the interface of the control circuit is one of the following connection types: pin-type connection means, flexible printed circuit means, PIN-PIN connection means, welding spot (VGA) thermal-melted connection means, ultrasonic welding device, solder-plate welding device or puncture-type connection means.

The said display screen is plasma panel or LCD, and there is provided a protective layer on the front surface of the display screen. According to the technical solutions described above, it is known that the present invention has advantages as the following:
1. Because the electromagnetic induction layer is placed behind the display screen and a wire lattice interlaced by the wires along the X and Y axial directions is adopted as a recognition induction element, it is easy to manufacture and the cost is low, also the greater the surface area, the more prominent the cost advantage is over the existing technology.
2. Because an electromagnetic induction wire lattice is adopted as a recognition induction element, its precision of recognition is high, and it is capable of accurately inputting mouse signals or pen track signals by means of pen touch or finger touch.
3. Signal generation is produced by means of an electromagnetic induction layer situated behind the display screen, and as a touch screen, a protective film is placed on the surface of the display screen, and it is not easy to cause physical damage, therefore the operating life is long.

### BRIEF DESCRIPTION OF THE DRAWINGS

FIG. 1 is a diagram showing the structure of an embodiment according to the present invention.

FIG. 2 is a diagram showing the structure of another embodiment according to the present invention.

FIG. 3 is a diagram showing the X and Y axial direction wire induction means of the induction layer according to the present invention.

FIG. 4 is a diagram showing the wires winded along Y axis of the induction layer according to the present invention.

FIG. 5 is a diagram showing the wires winded along X axis of the induction layer according to the present invention.

FIG. 6 is a diagram showing the whole structure of the induction cell formed by the wire lattice winded by the wires according to the present invention.

FIG. 7 is a diagram showing the structure of two induction layers overlaid together according to the present invention.

FIG. 8 is a diagram showing the connection between the induction layer and the induction control circuit that are separated according to the present invention.

FIG. 9 is a diagram showing the principle of the generation of the induction signal and the location identification of the input touch according to the present invention.

FIG. 10 is a diagram showing the connection between the output of the wire lattice and the corresponding input terminal of the printed circuit board or the means of electric connection according to the present invention.

FIG. 11 is a structural diagram showing the recognition circuit according to the present invention.

FIG. 12 is a diagram showing a method for winding the wires through the position reference columns according to the present invention.

FIG. 13 is an A-A profile of FIG. 12.

FIG. 14 is a diagram showing one position reference column according to the present invention.

FIG. 15 is a diagram showing another method for winding the wires through the position reference columns according to the present invention.

FIG. 16 is a diagram showing a method for winding the wires through position reference slots according to the present invention.

### DETAILED DESCRIPTION OF THE PREFERRED EMBODIMENTS

The present invention will be explained in detail with reference to the drawings and embodiments.

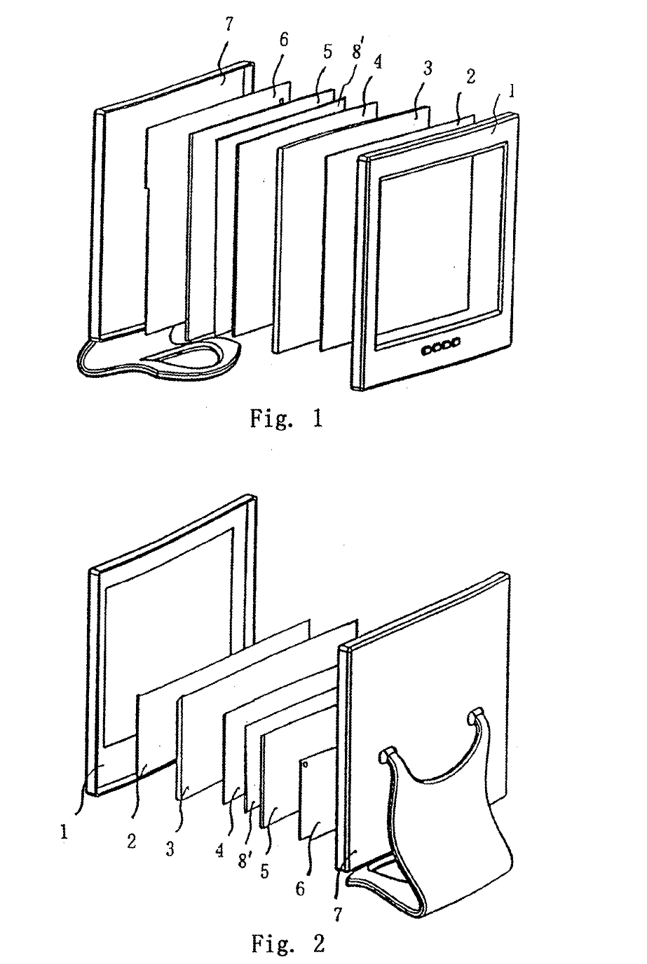

As shown in FIG. 1, a touch control display screen with a built-in electromagnetic induction layer of wire lattice according to the invention includes: a display screen 3 and a housing 1, 7 at least, an induction layer 4 is provided behind the display screen 3 and is connected to the induction collection control circuit by its output. A control circuit of the display screen is provided in the housing 1 and 7. The display screen 3 is a flat panel display screen such as plasma panel or LCD.

A characteristic point of the present invention is that the induction layer 4 is placed behind the display screen 3, and after the electromagnetic handwriting operation pen touches and presses the display screen 3, the induction layer 4 still can respond to the position contacted on the handwriting table through the display screen. In a concrete structural design, the surface area of the induction layer 4 is the same size as the surface area of the display screen 3. A shielding layer 5 is provided behind the induction layer 4, and a recognition circuit layer 6 is provided behind the shielding layer 5. The shielding layer 5 respectively insulates and shields between the induction layer 4 and the recognition circuit layer 6. Of course, the shielding layer 5 and the recognition circuit layer 4 may be separately placed in another space in the display screen or main unit. However, an entire induction device can be integrated by placing the insulating shielding isolating layer 5, the recognition circuit layer 6, and the touch control induction layer 4 affixed together. In order to further ensure the shielding effect, a spatial gap is provided between the shielding layer 5 and the recognition circuit layer 6. Of course, if a spatial gap is retained between the shielding layer 5 and the induction layer 6, there is already an insulating effect, and that shielding layer 5 itself may be a material not having an insulating layer. The shielding layer 5 is used for enhancing the anti-interference capability of the equipment.

Moreover, in order to increase the capabilities of wear resistance, and the like, of the surface of the display screen 3, a transparent protective layer or protective film 2 is provided on the front surface of the display screen 3.

A buffering layer 8′ is provided between the induction layer 4 and the shielding layer 5. The buffering layer 8′ is used to keep a reasonable space between the induction layer 4 and the shielding layer 5. Furthermore, the electromagnetic signal is transmitted from the pen in the both cases that the pen is pressed down and the pen is not pressed down, so as to control conveniently. Certainly, in a modification of the invention, the electromagnetic signal is not transmitted in the case that the pen is not pressed down. Furthermore, the pen can be provided with pressure induction means in order to sense the pressure by using different frequency.

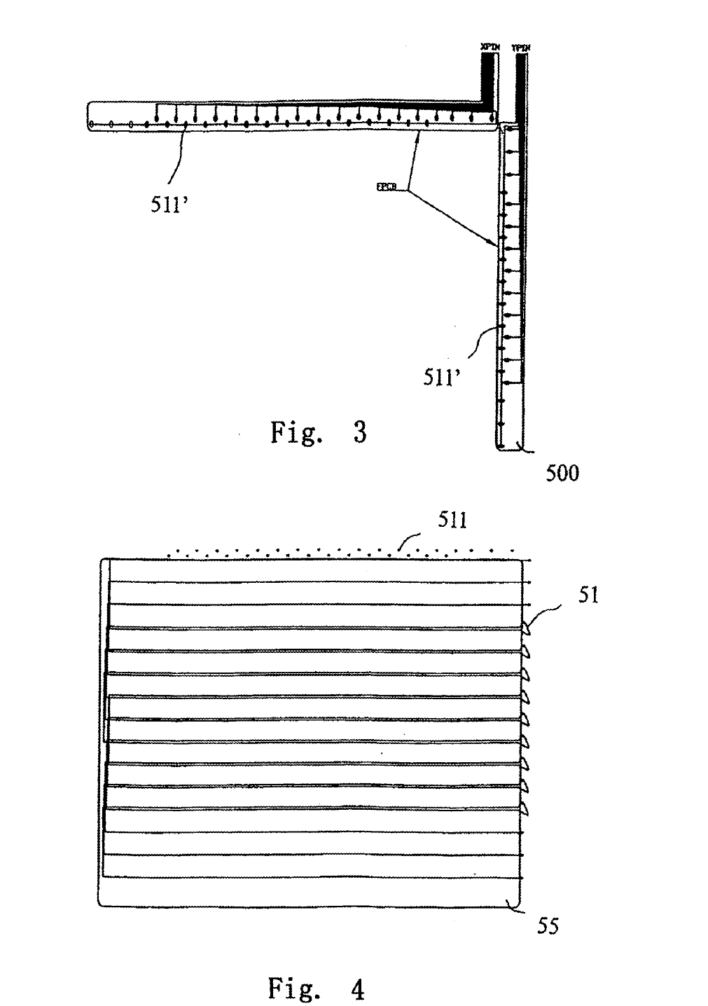

As shown in FIG. 2, according to different requirements, such as when a part of the display screen 3 is made as a touch input or touch operation area, the induction layer 4 may have a smaller surface area than the surface area of the display screen 3 and be placed on one side behind the display screen 3, and it also may be placed on two sides or four sides of the display screen 3. Of course, the induction layer 4 may have a larger surface area than the surface area of the display screen 3, such that the entire display screen 3 and the periphery of the display screen 3 may have touch control capability.

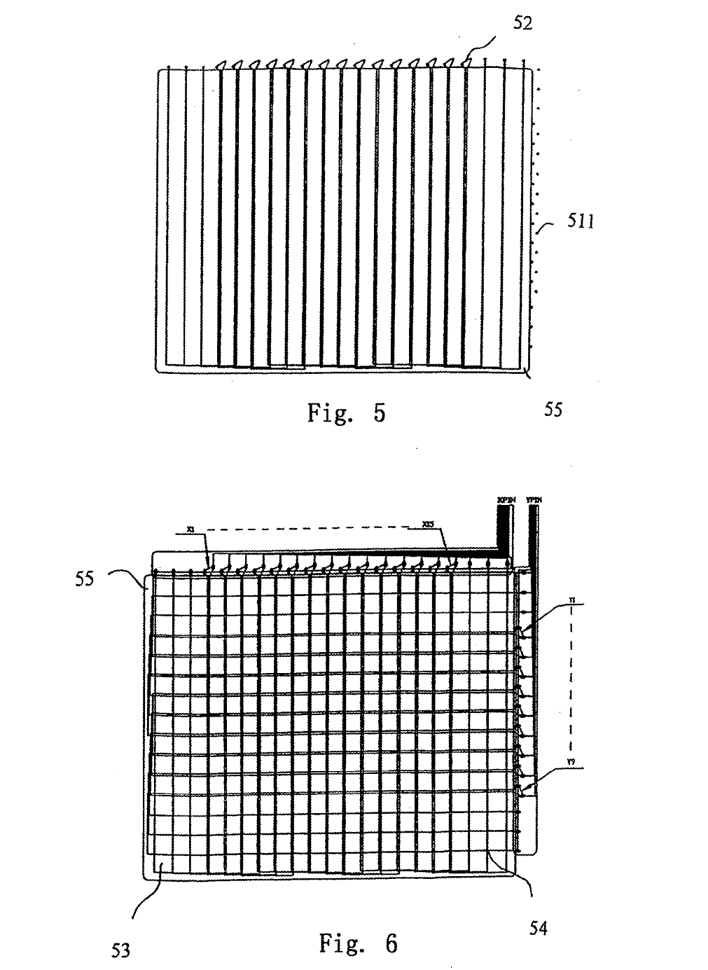

As shown in FIGS. 3, 4, 5 and 6, the induction layer 4 may be a wire lattice winded and interlaced by the wires 51 along the X axis and the wires 52 along the Y axis, and the wires are insulated with each other at the crossing points 54. The space enclosed by each lattice unit constitutes one induction cell 53. There can be position reference columns 511 while winding. The surface of the wires is wholly covered or coated by an insulated layer. Alternatively, the enameled wires along the X and Y axes can wind the wire lattice. As can be seen from FIGS. 4 and 5, the wires 51 have latitudes across the display screen along X direction and the wires 52 have longitudes across the display screen along Y direction. FIG. 6 illustrates the complete wire lattice laid out in a conventional coordinate system in which X and Y axes are perpendicular to each other with orthogonal X and Y directions.

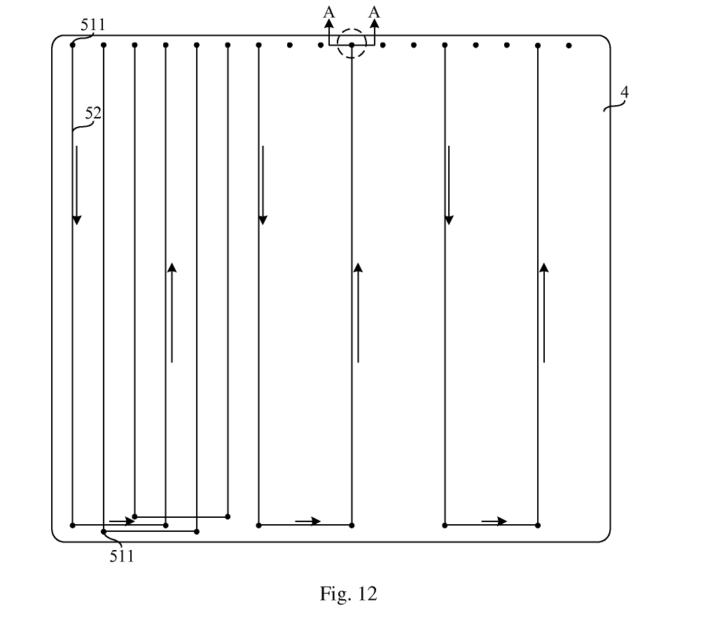

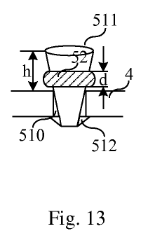

FIG. 12 is a diagram showing a method for winding the wires through the position reference columns according to the present invention, and FIG. 13 is an A-A profile of FIG. 12. As shown in FIGS. 12 and 13, there are via holes 510 around the electromagnetic induction layer 4, and the position reference columns 511 pass through the via holes 510 and stretchy stop blocks 512 connected to the bottom of the position reference columns 511 are provided for locking the position reference columns 511 to fix in the via holes 510. When wiring the wires 52 along the Y direction, the wires 52 are winded through the position reference columns 511, and the winding direction is shown by the arrow in FIG. 12.

Each of the wires 52 in U shape has two ends, one of which is connected to the induction control circuit and the other is connected to the ground. The resistance value of each of the wires 52 may be less than 400Ω, so that the diameter of the wire 52 is upon the length of the wire 52. The diameter of the wire 52 can be 0.1 mm˜0.8 mm as an example. In addition, the height of the position reference columns 511 which is above the electromagnetic induction layer 4 should be larger than the diameter of the wire 52. As shown in FIG. 13, the height h is higher than the diameter d. The material of the position reference columns 511 may be insulating plastics. In order to reducing the intervals among the wires 52, it can be realized by reducing the intervals among the position reference columns 511.

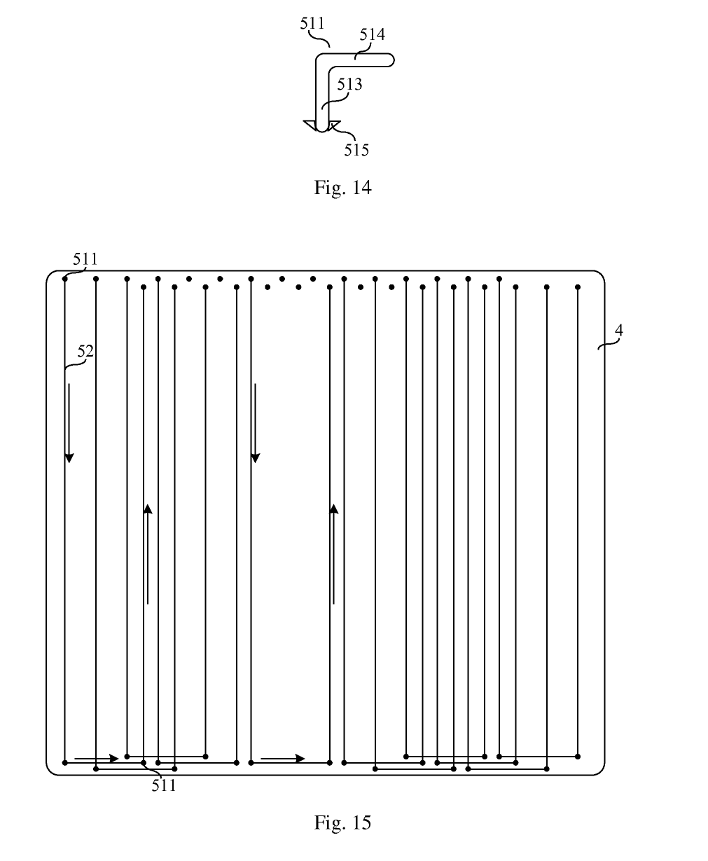

FIG. 14 is a diagram showing one position reference column according to the present invention. A first line 512 is fixed on the electromagnetic induction layers 4 vertically for winding the wires 52. A second line 513 is connected to the first line 512 and parallel to the electromagnetic induction layer 4 for preventing the wires 52 from falling off from the position reference column 511. However, the structure of the position reference column 511 is not limited to the above structures which are in the FIGS. 13 and 14. The position reference column 511 can be any shape which can be steady around the electromagnetic induction layer 4 to realize the wires winded.

FIG. 15 is a diagram showing another method for winding the wires through the position reference columns according to the present invention. In order to distinguish the end connected to the ground and the end connected to the induction control circuit, the position reference columns 511 intercross around the electromagnetic induction layer 4. As shown in FIG. 15, the end of the wire 52 winded around the position reference column 511 which is closer to the upper edge of the electromagnetic induction layer 4 is connected to the induction control circuit, and the end of the wire 52 winded around the position reference column 511 which is farther from the upper edge of the electromagnetic induction layer 4 is connected to the ground.

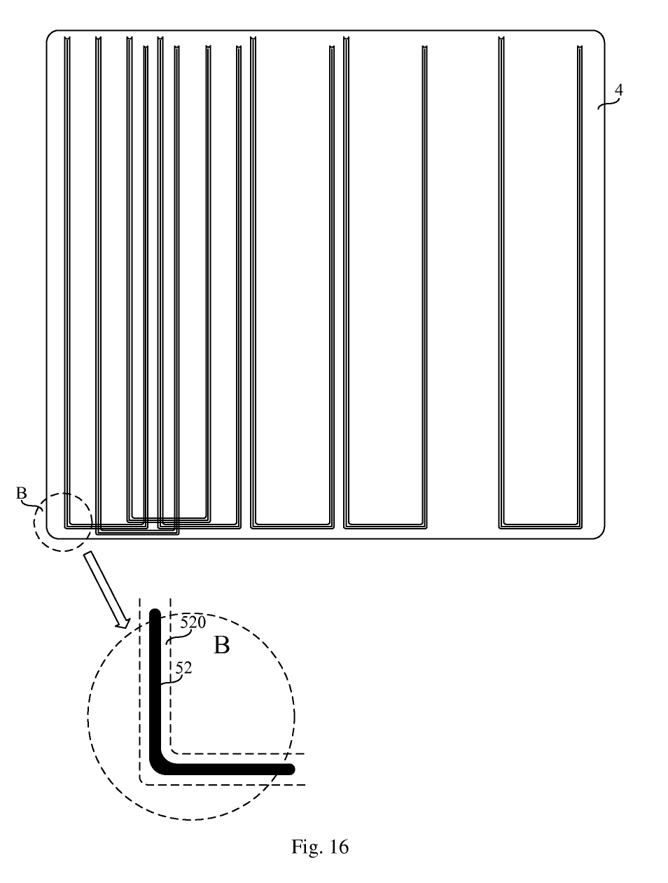

FIG. 16 is a diagram showing a method for winding the wires through position reference slots according to the present invention. There are several slots 520 in U shape set on the electromagnetic induction layer 4, and the wires 52 is set according to the direction of the slots 520. Each of the wires 52 in U shape has two ends, one of which is connected to the induction control circuit and the other is connected to the ground.

In order to position the winded wire lattice strictly, for the subsequent technique and maintenance the wire lattice can be attached and fixed on the electromagnetic induction layer 4 by thermal pressing or thermal melting process. The electromagnetic induction layer 4 can be an insulated membrane, and the insulated membrane may be film material. Specifically, the thermal pressing process is heating the electromagnetic induction layer 4 on which attaches the wire lattice at a certain temperature to make the insulated layer covering the wire 52 in a half-melting status, and then forcing a certain pressure to the wire 52 to joint the insulated layer in the half-melting status on the electromagnetic induction layer 4, and passing a cooling process to steady the wire 52 on the electromagnetic induction layer 4. The thermal melting process is, when the material of the insulated layer covering the wire 52 is the same as the material of the electromagnetic induction layer 4, heating the electromagnetic induction layer 4 on which attaches the wire lattice at a certain temperature to make the electromagnetic induction layer 4 and the insulated layer covering the wire 52 in a half-melting status, and then melting the electromagnetic induction layer 4 and the insulated layer together, and passing a cooling process to steady the wire 52 on the electromagnetic induction layer 4.

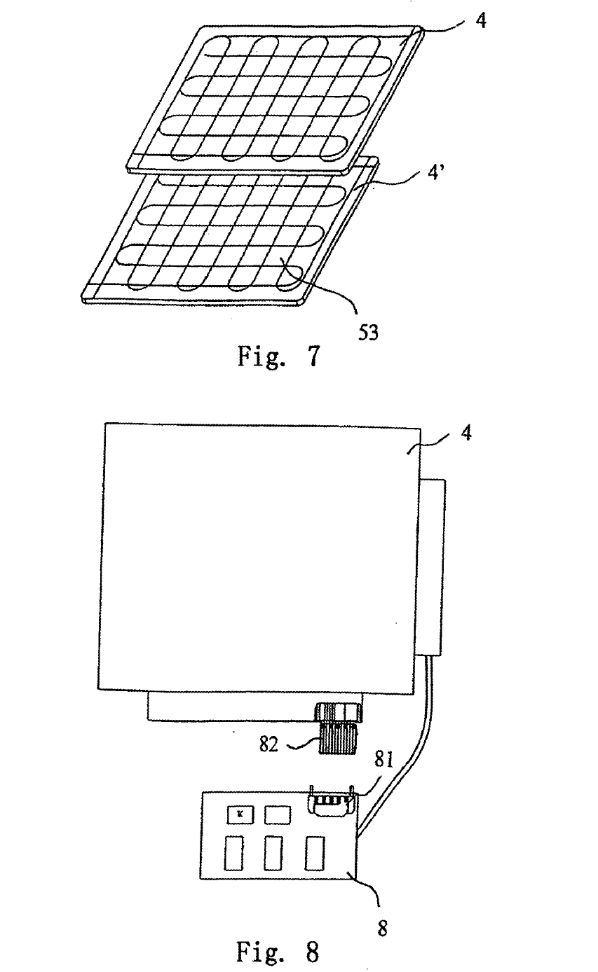

As shown in FIG. 7, more than one induction layer 4 and 4′ are overlaid together and the induction cells 53 on respective induction layers are set to interlace each other, so as to improve the accuracy of the touch display screen. The interval sizes of the said induction cells 53 on respective layers may be same or different. After the induction layers in which each layer has different interval size of the induction cells 53 are overlaid together, the scale unit of the coordinates is consequentially shorten, so the accuracy of induction is improved. In the case that the induction layers having same size of the induction cells 53 are overlaid together, because the induction cells 53 on different induction layers are set to interlace each other, the scale unit of the coordinates can also be shorten, and so the sensitivity of the touch display screen is improved.

The induction collection control circuit of the induction layer 4 and the output of the wire lattice of the induction layer are integrated by direct connection, the components of the induction collection control circuit are positioned on the output of the wire lattice, and the induction collection control circuit is positioned in the housing. For example, when the flexible printed circuit (FPC) wire lattice is used, they are integrated. The wire lattice and the induction collection printed circuit are etched at one time, and the control elements are provided thereon, so as to improve the manufacture efficiency and adapt for industrialized production.

The said components of the induction collection control circuit can also be mounted on a printed circuit board that is separated from the induction layer 4; the output of the wire lattice of the induction layer is connected to the corresponding input terminal on the printed circuit board by means of pressure-connection, plug-in connection or welding connection.

As shown in FIG. 10, the output of the wire lattice of the induction layer 4 is positioned between a hard sheet 600 and a printed circuit board 500. A buffering layer 8′ is positioned between the hard sheet 600 and the output of the wire lattice. The hard sheet 600, buffering layer 8′ and the output of the wire lattice are overlaid on the printed circuit board 500 by means of the screwing and pressing connection 700. The output of the wire lattice is connected with corresponding input terminal 511′ on the printed circuit board 500.

The printed circuit board may be a printed circuit board of the control circuit of the display screen inside the body of the display screen, so as to integrate the control elements, reduce the components and lower the cost.

As shown in FIG. 8, the components of the induction collection control circuit may be positioned on the printed circuit board 8 that is separated from the induction layer 4 and integrated with the control circuit of the display screen, and of course be positioned outside the display screen body like PC. The output 82 of the wire lattice of the induction layer is connected with the input induction terminal 81 of the printed circuit board by means of pressure-connection, plug-in connection or welding-connection. The connection can be achieved with existing usual standard interfaces, for example, the output interface 82 of the induction layer and the interface 81 of the control circuit may be one of the following connection types: pin-type connection means, flexible printed circuit means, PIN-PIN connection means, welding spot (VGA) thermal-melted connection means, ultrasonic welding device, solder-plate welding device and puncture-type connection means.

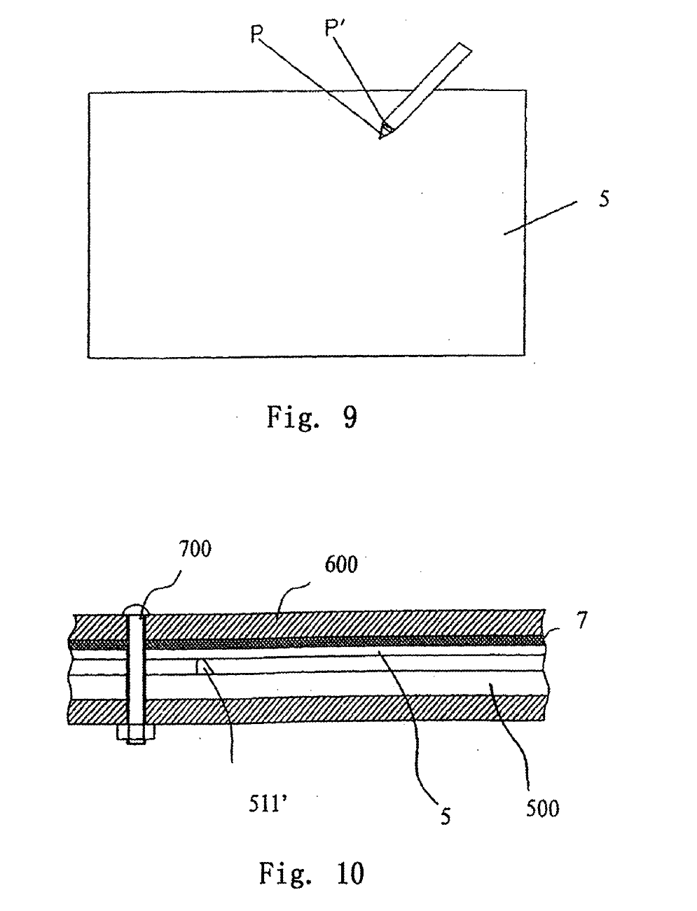

The operation mechanism of the present invention is as shown in FIG. 9. In FIG. 9, P is the signal input terminal of the pen, and there is a bigger conductor P′ on the head of the pen, the electromagnetic pen transmits electromagnetic signal continuously. When the pen-point touches the induction generation device, said electromagnetic signal passes through the induction antenna at the corresponding location, and then the antenna at the location induces a signal. The location signal induced by the induction generation device is transferred to the input terminal of the control identification circuit through the wire along X, Y axes. After array selecting, control process, band-pass filtering, detection rectification and A/D conversion, the resultant location signal is transferred to the processing circuit and calculated by the CPU, so as to determine the location coordinates of the electromagnetic signal on the induction antenna and various operation statuses. Above data or information is sent to a computer through communication interfaces, thereby to control the computer to identify, display, record and so on.

Furthermore, in order to obtain the pressure of pen-point while writing and to improve the induction accuracy of the location signal, a Z-axis directional pressure sensor is provided in the tail of the pen-point, and the output of the sensor is connected to the control terminal of the electromagnetic wave generation device, so the transmitted electromagnetic wave signal can be changed by means of pressure-touching, thereby the pressure (input signal) of the pen-point can be identified more reliably. The position of the pen can be determined according to the plane coordinate of the position of the pen.

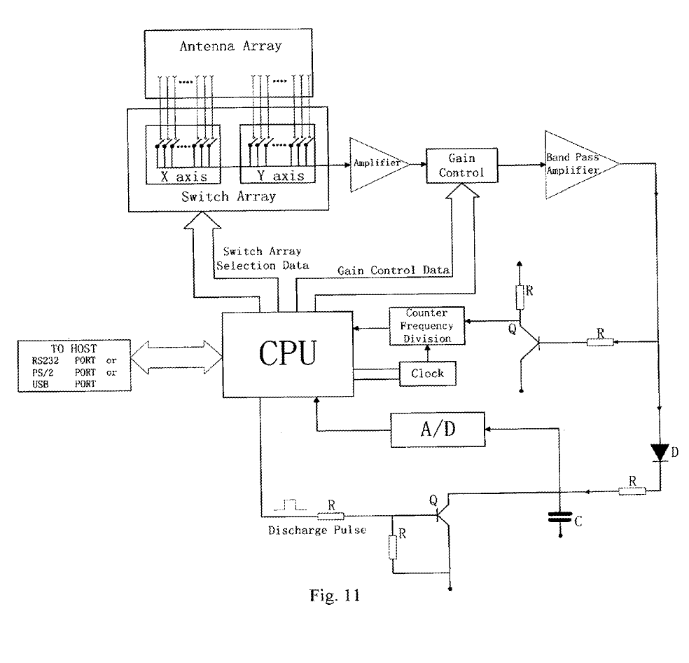

As shown in FIG. 11, the induced electromagnetic signal source is the electromagnetic operation pen, the electromagnetic handwriting operation pen transmits constant frequency or data electromagnetic signal continuously normally. After the pen-point is pressed, and touches the device, the electromagnetic signal of the induction generation device passing through the wire lattice, the bottom of the horizontal antennas and the top of the vertical antennas at the location corresponding to the center or around area of the electromagnetic signal source induce the electromagnetic signal. The electromagnetic signal induced is transferred to CPU through the interface of the recognition circuit. The CPU calculates the positions of the induction antennas, the intensity of the voltage and the variation of the frequency signal so as to determine the position of the electromagnetic signal source and various operation statuses, and the results above are transferred to CPU so as to control the computer to achieve various commands, such as character or shape identification, drawing or shortcut key transferring.

The electromagnetic pen transmits electromagnetic signal continuously. When the pen-point touches the induction generation device, said electromagnetic signal passes through the induction antenna at the corresponding location, and then the antenna at this location induces a signal. The location signal induced by the induction generation device is transferred to the input terminal of the control identification circuit through the wires along the X, Y axes. After array selecting, control process, band-pass filtering, detection rectification and A/D conversion, the resultant location signal is transferred to the processing circuit and calculated by the CPU, so as to determine the location coordinates of the electromagnetic signal on the induction antenna and various operation statuses. Above data or information is sent to a computer through communication interfaces, thereby to control the computer to identify, display, record and so on.

Furthermore, in order to obtain the pressure of pen-point as writing and to improve the induction accuracy of the location signal, a Z-axis directional pressure sensor is provided in the tail of the pen-point, and the output of the sensor is connected to the control terminal of the electromagnetic wave generation device, so the transmitted electromagnetic wave signal can be changed by means of pressure-touching, thereby the pressure (input signal) of the pen-point can be identified more reliably.

The present invention can be widely used in all kinds of touch control equipments. At the same time, the concept of the invention is by no means limited to combining an electromagnetic induction layer and a flat panel display screen, and electromagnetic induction layers can be combined behind non-CRT display screens such as plasma display screens and liquid crystal display screens having all kinds of shapes that are not at all flat so as to achieve a low cost touch screen structure.

Above embodiments are used only to explain the present invention, but not to limit the present invention. In despite of the detailed description of the present invention with referring to above preferred embodiments, it should be understood that various modifications, changes or equivalent replacements can be made by those skilled in the art without departing from the spirit and scope of the present invention. All of the modifications, changes or equivalent replacements should be covered in the append claims of the application.

What is claimed is:

1. A touch control display screen with a built-in electromagnetic induction layer of wire lattice, comprising:
a display screen and a housing;
one or more electromagnetic induction layer being provided behind the display screen, each said electromagnetic induction layer including a wire lattice and position reference columns provided around said electromagnetic induction layer, said wire lattice being formed by a first wire winded around said position reference columns along a first direction with longitudes across the display screen and a second wire winded around said position reference columns along a second direction orthogonal to said first direction with latitudes across the display screen, said first and second wires being interlaced separately with said longitudes crossing said latitudes to form a plurality of induction cells, and the wire lattices of respective electromagnetic induction layers being set to interlace each other;
an induction control circuit connected to an output of said wire lattice of said electromagnetic induction layer; and
a display screen control circuit being provided in the housing;
wherein said first and second wires have respective reference positions and are insulated with each other at crossing points of said first and second wires.

2. The touch control display screen with a built-in electromagnetic induction layer of wire lattice according to claim 1, wherein a shield layer is provided behind said electromagnetic induction layer in order to enhance anti-interference ability of said touch control display screen.

3. The touch control display screen with a built-in electromagnetic induction layer of wire lattice according to claim 2, wherein a buffering layer is provided between said electromagnetic induction layer and said shielding layer.

4. The touch control display screen with a built-in electromagnetic induction layer of wire lattice according to claim 3, wherein a spatial gap is kept between said shielding layer and said display screen control circuit.

5. The touch control display screen with a built-in electromagnetic induction layer of wire lattice according to claim 1, wherein said first and second wires are enameled wires that are coated with an insulated layer.

6. The touch control display screen with a built-in electromagnetic induction layer of wire lattice according to claim 1, wherein said induction control circuit and said electromagnetic induction layer are integrated by direct connection, components of said induction control circuit are directly positioned at said output of said wire lattice, and said induction control circuit is positioned in said housing.

7. The touch control display screen with a built-in electromagnetic induction layer of wire lattice according to claim 1, wherein components of said induction control circuit are mounted on a printed circuit board that is separated from said electromagnetic induction layer; said output of said wire lattice of said electromagnetic induction layer is connected to a corresponding input terminal on said printed circuit board by means of pressure-connection, plug-in connection or welding connection.

8. The touch control display screen with a built-in electromagnetic induction layer of wire lattice according to claim 7, wherein said output of said wire lattice of said electromagnetic induction layer is positioned between a hard sheet and said printed circuit board; a buffering layer is positioned between said hard sheet and said output of said wire lattice; said hard sheet, said buffering layer and said output of said wire lattice are overlaid on said printed circuit board by means of screwing and pressing connection; and said output of said wire lattice is connected to said corresponding input terminal on said printed circuit board.

9. The touch control display screen with a built-in electromagnetic induction layer of wire lattice according to claim 7, wherein said printed circuit board is a printed circuit board of said display screen control circuit located inside said housing of said touch control display screen.

10. The touch control display screen with a built-in electromagnetic induction layer of wire lattice according to claim 1, wherein said display screen control circuit is located outside said touch control display screen.

11. The touch control display screen with a built-in electromagnetic induction layer of wire lattice according to claim 1, wherein said induction control circuit is positioned outside said touch control display screen and connected to said touch control display screen through an electrical connection means; said output of said wire lattice of said electromagnetic induction layer is connected with an output interface of said electromagnetic induction layer by means of pressure-connection, plug-in connection or welding-connection; and an interface matching said output interface of said electromagnetic induction layer is provided on said induction control circuit.

12. The touch control display screen with a built-in electromagnetic induction layer of wire lattice according to claim 11, wherein said output interface of said electromagnetic induction layer and said interface of said induction control circuit are one of the following connection types: pin-type connection means, flexible printed circuit means, PIN-PIN connection means, welding spot (VGA) thermal-melted connection means, ultrasonic welding device, solder-plate welding device, or puncture-type connection means.

13. The touch control display screen with a built-in electromagnetic induction layer of wire lattice according to claim 1, wherein a protective layer is provided on a front surface of said display screen.

14. The touch control display screen with a built-in electromagnetic induction layer of wire lattice according to claim 1, wherein said display screen is a plasma panel or LCD.

15. The touch control display screen with a built-in electromagnetic induction layer of wire lattice according to claim 1, wherein the induction cells formed by the wire lattices on different electromagnetic induction layers have different sizes.

16. The touch control display screen with a built-in electromagnetic induction layer of wire lattice according to claim 1, wherein said position reference column intercrosses around said electromagnetic induction layer.

17. The touch control display screen with a built-in electromagnetic induction layer of wire lattice according to claim 1, wherein said position reference column comprises a first section for winding said wires, and a second section for preventing said wires from falling off from said position reference columns.

18. The touch control display screen with a built-in electromagnetic induction layer of wire lattice according to claim 1, wherein said position reference column has an inverted conical structure.
